(19) United States
(12) Patent Application Publication
(10) Pub. No.: US 2007/0081686 A1
(43) Pub. Date: Apr. 12, 2007

(54) Hearing aid

(75) Inventor: Klaus-Dieter Sluppke, Hamburg (DE)

Correspondence Address: RANKIN, HILL, PORTER & CLARK LLP, 4080 ERIE STREET, WILLOUGHBY, OH, 44094-7836, US

(73) Assignee: HANSATON AKUSTIK GMBH, Hamburg (DE)

(21) Appl. No.: 11/247,351

(22) Filed: Oct. 11, 2005

(51) Int. Cl. H04R 25/00

(52) U.S. Cl. 381/330; 381/322

(57) ABSTRACT

In accordance with the present invention, a behind the ear type hearing aid device is provided that includes a one piece case that defines an opening at a first end. The hearing aid also includes a carriage that supports the electrical components of the hearing aid. The carriage, including the electrical components, is easily inserted inside of case, thus, simplifying the assembly process significantly. The opening of the case is selectively closed using a door that is pivotally attached to the case. The door includes a battery compartment into which a typical disc-shaped battery fits.

### BACKGROUND OF THE INVENTION

1. Field of the Invention

The present invention applies to hearing aids and more specifically hearing aids having a minimal number of case parts.

2. Description of the Related Art

Hearing aids have become more sophisticated in the past decades and also more affordable. Technology that has led to smaller electronic circuits and components used therewith has also allowed engineers to develop smaller hearing aids. Modern hearing aids are typically one of two general types: in the ear aids where the speaker as well as the microphone and other electrical components do not protrude outside of the ear's antihelix, and behind the ear aids where an earpiece is placed in the ear canal, but the electrical components are held behind the ear itself in a case. A variation of a behind the ear hearing aid also includes the speaker within the earpiece that is placed in the ear canal.

Reducing the size of hearing aids has not made assembling the hearing aids easier, however. One step of the assembling process that is difficult is placing and attaching the electrical components to and inside the case. Typically the case is formed in two halves and the electrical components are attached to one half of the case. The second half of the case is then attached to the first half in order to enclose the electrical components. This process entails a number of assembly steps and leaves the case with an unsightly seam where the two halves come together.

What is desired is a simpler and faster way to assemble a small, modern hearing aid, resulting in a hearing aid with a pleasing appearance.

### BRIEF SUMMARY OF THE INVENTION

The present invention overcomes these and other disadvantages in the prior art. The hearing aid of the present invention provides a one-piece case into which the necessary electrical components are easily inserted.

In accordance with the present invention, the hearing aid is a behind the ear type device that includes a one piece case that defines an opening at a first end. The hearing aid also includes a carriage that supports the electrical components of the hearing aid. The carriage, including the electrical components, is easily inserted into the case through the defined opening, thus, simplifying the assembly process significantly. The opening of the case is selectively closed using a door that is pivotally attached to the case. The door includes a battery compartment into which a common disc-shaped battery fits.

These and other features, aspects and advantages of the present invention will be fully described by the following description, appended claims, and accompanying drawings.

### BRIEF DESCRIPTION OF THE FIGURES

FIG. 1 is an exploded view of the hearing aid of the present invention;

FIG. 2 is a perspective view of the hearing aid of the present invention with the component carriage and components being loaded into the case and with the door ajar; and

FIG. 3 is a second perspective view of the hearing aid with the door closed.

### DETAILED DESCRIPTION OF THE INVENTION

Referring to the drawings, a preferred hearing aid 10 according to the present invention is illustrated. The hearing aid 10 includes a case 12, a group of electrical components 14, a carriage 16 supporting the electrical components 14, a door 18 that includes a battery compartment 20, an earpiece 22, a sound conductor 24 and a series of pins 28, 30, 31 for holding parts of the hearing aid 10 together.

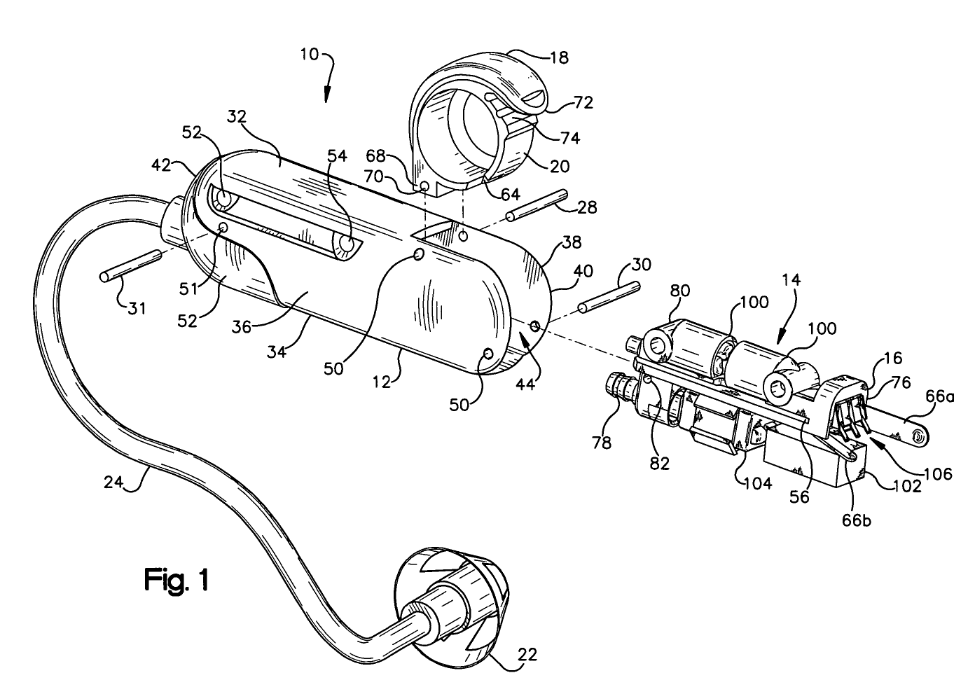

Referring to FIG. 1, the case 12 is shown and has a generally rectangular body with four walls (top 32, bottom 34, front 36, rear 38) with first and second curved ends 40 and 42. The edges between the four walls are rounded. The case 12 is hollow. The first end 40 of the case 12 defines an opening 44 through which the electrical component carriage 16 is inserted. The opening 44 extends, on the top wall 32 of the case 12, from the first end 40 significantly toward the center of the top wall 32. The opening extends, on a bottom wall 34 of the case 12, from the first end 40 slightly toward the center of the bottom wall 34. The opening does not protrude into the front or rear walls 36 and 38 of the case 12.

The case 12 also defines a number of smaller openings 50 and 51, each for receiving one end of a pin 28, 30, 31 used to hold elements of the hearing aid 10 together. An additional opening (not shown) is defined in the second end 42 of the case 12, but is covered by a junction piece 52 described below.

A junction piece 52 is placed at a second end 42 of the case 12 between the case 12 and sound conductor 24. The junction piece 52 overlaps the second end 42 of the case 12 and a portion of the bottom wall 34, front wall 36 and rear wall 38 of the case 12. The case 12 also defines one or more apertures 54 for the passage of sound from the outside of the hearing aid 10 to microphones 100 on the inside of the hearing aid 10.

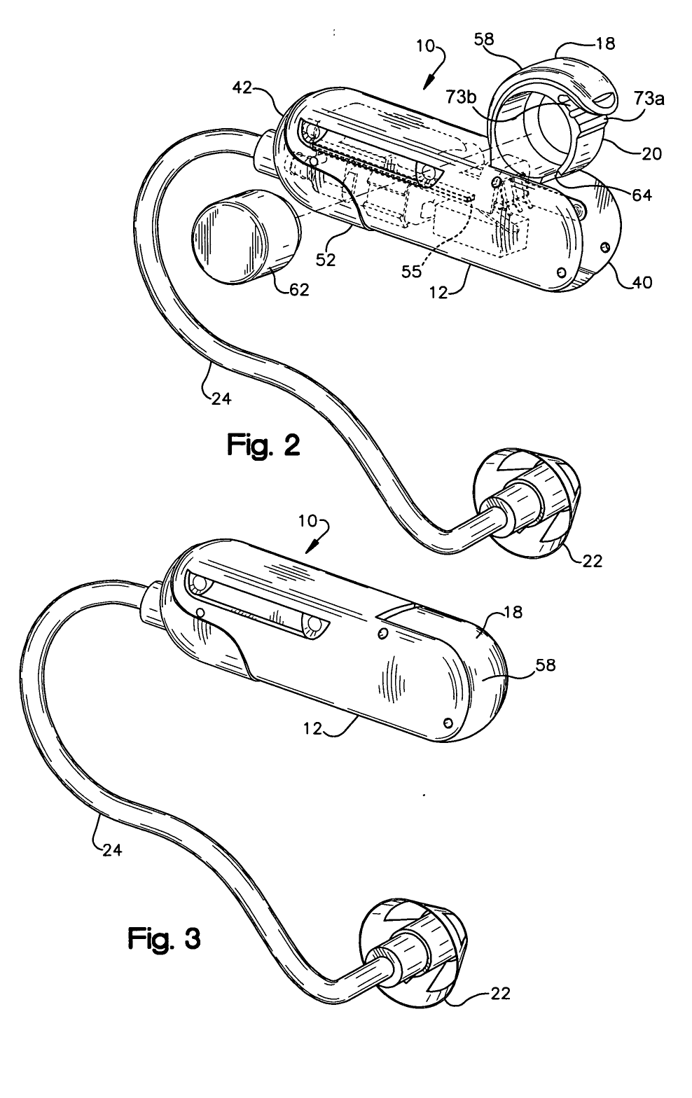

Referring to FIGS. 1 and 2, the inside of the front wall 36 and rear wall 38 of the case 12 include rails 55 that protrude from the respective inside walls. The rails are received in corresponding grooves 56 within the component carriage 16, thus, guiding the component carriage 16 during insertion and maintaining the component carriage 16 in a desired orientation. When the carriage 16 is placed inside the case 12, there is little clearance between the carriage 16 and case 12, thus, the case size is minimized. The position of the rails and grooves may be reversed such that the rails are on the carriage 16 and the grooves on the case 12.

The sound conductor 24 is a tube well known in the art for carrying sound without distortion from a speaker 104 within the case 12 to the earpiece 22. The sound conductor 24 is semi-rigid and acts to secure the hearing aid 10 to the user's ear. The sound conductor 24 is bendable and can be placed into the necessary shape to conform to the user's ear. The earpiece 22 is shaped in the form of a cone for fitting in the user's ear and is provided at the end of the sound conductor 24 opposite the junction with the case 12. The design of the earpiece 22 is well known by those having ordinary skill in the art.

Referring to FIGS. 2 and 3, a door 18 is pivotally fixed to the first end 40 of the case 12. The door 18 includes an outer wall 58 that matches the curvature of the case 12 as defined by the top, bottom, front and rear walls 32, 34, 36 and 38. As a result, when the door 18 is in a closed position, the door 18 blends into the case 12 and is not readily apparent that the door 18 is a separate component from the case 12. Formed within an inner portion of the door 18 is a circular compartment 20 that holds a disc shaped battery 62, similar to a battery most well known in the art for use in watches. The battery 62, when received in the compartment 20, is oriented with the battery thickness parallel to the axis around which the door 18 pivots.

Referring back to FIGS. 1 and 2, the battery compartment 20 defines one or more gaps 64 through which battery terminal contact fingers 66a and 66b pass. A first end of the door 68, which is adjacent the top wall 32 of the case 12, defines a cylindrical passage 70 extending through the door 18 transverse to the longitudinal axis of the case 12. The second end 72 of the door 18, which is adjacent to the bottom wall 34 of the case 12, defines an arcuate trough 74, disposed between a pair of ribs 73a, 73b extending transverse to the longitudinal axis of the case 12. The ribs 73a, 73b serve to engage a pin 30 to hold the door 18 in either of first and second closed positions described hereafter.

The hearing aid 10 is turned “on” or “off” depending on the position of the door 18. When the door 18 is in a position shown in FIG. 2 the hearing aid 10 is “off”. As the door 18 is pivoted toward the bottom wall 34 a first rib 73a engages the pin 30, and then resiliently snaps over the pin 30 such that the pin 30 is received within trough 74. At this point, the door is in a first or partially closed position, and the hearing aid is still “off”. As the door 18 is further moved toward the bottom wall 34, a second rib 73b engages the pin 30 and then resiliently snaps over the pin 30. At this point the door 18 is in the second or fully closed position, and the battery 62 is moved into electrical contact with battery contact terminals 66a (negative) and 66b (positive), and the hearing aid is “on”. This fully closed position is shown in FIG. 3.

Referring back to FIGS. 1 and 2, the generally rectangular carriage 16 supports the electrical components 14 used within the hearing aid 10. The electrical components 14 include at least microphones 100, an amplifier hybrid 102, a loud speaker 104 and battery terminal contacts 66a and 66b. The first and second battery terminal contacts 66a and 66b protrude from a first end 76 of the carriage 16 and fit against the battery 62 when the battery 62 is seated in the battery compartment 20 and the door 18 is in the fully closed position. The electrical components 14 also include programming contacts 106. An external device (not shown) is attached to the contacts 106 and the hearing aid may then be reprogrammed. A barbed tube fitting 78 protrudes from the second, opposite, end 80 of the carriage 16. The second end 80 of the carriage 16 also defines a cylindrical passage 82 extending transverse to the longitudinal axis of the case 12 to receive pin 31.

In an alternate embodiment of the invention, the battery is also supported on the carriage and the door does not include a battery compartment.

The volume of the hearing aid is preferably set during a reprogramming operation where an external device is connected to the programming contacts 106. Alternatively, a volume control device such as a potentiometer (not shown) is used and includes a control knob that extends through one of the walls, such as the top wall 32.

The hearing aid 10 is assembled at the factory in a minimum number of steps. Preferably the junction piece 52, sound conductor 24 and earpiece 22 are integrally formed. The junction piece 52 is snapped into connection with the case 12. The door 18 is attached to the case 12 using a pin 28 that is passed first through an aperture 50 in the case 12, then through the cylindrical passage 70 in the first end 68 of the door 18 and then through a second aperture 50 in the case 12. The carriage 16 is slid into the case 12 with the door 18 in an open position. Grooves 56 within the carriage 16 fit into rails 55 on the inside of the case 12, thus, keeping the carriage 16 in a preferred orientation. The carriage 16 is pushed into the case 12 until the passage 82 in the second end 80 of the carriage is aligned with apertures 51 within the case 12. A pin 31 is pushed through the case and the passage 82 when the carriage 16 is inserted to the appropriate position to lock the carriage 16.

In an alternate embodiment of the invention, instead of a pin 31, two stub shafts (not shown) are integrally formed with the carriage and snap into the apertures 51, or similar receptacles, within the case to lock the carriage 16 in a preferred position.

When the battery 62 needs to be replaced, the door 18 is simply pivoted to an open position, the battery 62 pulled out and replaced and the door 18 closed again. If one of the electrical components 14 of the hearing aid fails or is found to be defective, the carriage 16 including the electrical components 14 can be removed after the pin 31 (or two stub shafts) securing the carriage 16 is removed from the case 12.

The present invention is an improvement over the prior art because the hearing aid utilizes a one piece case that does not include unsightly seams that are inherent with cases formed of two halves. Additionally, the hearing aid is easy to assemble, the electronic components are supported on a carriage that is slid into the case and secured with a stubs or a pin. The one piece case and carriage combined provide a hearing aid that is smaller than other behind the ear type hearing aids known in the art.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents.

What is claimed is:

1. A behind the ear type hearing aid comprising:
a component carriage supporting a microphone and an amplifier;
a one piece case configured to fully enclose said component carriage after said component carriage is inserted through an opening defined in a first end of said case; and
a door pivotally attached to the first end of said case for selectively covering said opening defined therein.

2. The hearing aid of claim 1, further comprising a battery compartment formed as part of said door.

3. The hearing aid of claim 1, further including a pin for securing said component carriage within said case.

4. The hearing aid of claim 1, wherein said case is a generally rectangular body with curved edges and wherein said first end is rounded and a second opposite end is rounded.

5. The hearing aid of claim 1, wherein said door is pivotally attached to the first end of said case using a first pin and a second pin selectively holds said door closed.

6. The hearing aid of claim 5, wherein said second pin selectively holds said door in one of two closed positions wherein in said first position the hearing aid is “off” and in said second position the hearing aid is “on”.

7. The hearing aid of claim 2, wherein said battery compartment further includes one or more gaps allowing battery contact terminals supported by said component carriage to contact a battery supported by said battery compartment.

8. A method of assembling a behind the ear type hearing aid comprising the steps of:
providing a component carriage supporting a microphone and an amplifier, and providing a one piece case configured to fully enclose said component carriage;
inserting said component carriage through an opening defined in a first end of said case.

9. A behind the ear type hearing aid comprising:
a component carriage supporting a microphone and an amplifier,
a case defining an opening through which the component carriage is insertable, and
a door pivotally attached to said case for selectively covering said opening defined therein.

10. The hearing aid of claim 9, wherein said case defines first guidance means on an inside surface and said component carriage defines corresponding second guidance means whereby said first and second guidance means are form fitted and provide sliding engagement between said component carriage and said case during removal or insertion of said component carriage.
